(19) United States
(12) Patent Application Publication
(10) Pub. No.: US 2013/0063391 A1
(43) Pub. Date: Mar. 14, 2013

(54) RESISTIVE OVERLAY-TYPE TOUCH SENSOR FOR TOUCH SCREEN PANEL AND METHOD FOR FABRICATING THE SAME

(71) Applicants: Seok-Myong KANG, Hwaseong-si (KR); Shi-Yun CHO, Anyang-si (KR); Ho-Seong SEO, Suwon-si (KR)

(72) Inventors: Seok-Myong KANG, Hwaseong-si (KR); Shi-Yun CHO, Anyang-si (KR); Ho-Seong SEO, Suwon-si (KR)

(73) Assignee: Samsung Electronics Co., Ltd., Suwon-si (KR)

(21) Appl. No.: 13/333,244

(22) Filed: Dec. 21, 2011

(30) Foreign Application Priority Data
Sep. 8, 2011 (KR) 10-2011-0091299

(51) Int. Cl. G06F 3/045; H01H 11/00

(52) U.S. Cl. 345/174; 29/622

(57) ABSTRACT

A resistive overlay-type touch sensor for a touch screen panel and a method for fabricating the same are provided, in which a plurality of first substrates are extended in parallel along a first direction, a plurality of second substrates are extended in parallel along a second direction perpendicular to the first direction, and a plurality of transparent electrodes are formed on the first and second substrates. The second substrates intersect with the first substrates, each second substrate facing alternately one and the other surfaces of the first substrates along the second direction, and each of the transparent electrodes on the first substrates faces one of the transparent electrodes on the second substrates.

### PRIORITY

This application claims priority under 35 U.S.C. §119(a) to a Korean Patent Application filed in the Korean Intellectual Property Office on Sep. 8, 2011 and assigned Serial No. 10-2011-0091299, the contents of which are incorporated herein by reference.

### BACKGROUND OF THE INVENTION

1. Field of the Invention

The present invention relates generally to a touch screen, and more particularly, to a resistive overlay-type touch sensor for a touch screen panel.

2. Description of the Related Art

A touch screen generally includes a touch screen panel of the same size as a display screen, for sensing a touched point based on an electrical variation caused by a user's manipulation on the display screen. The touch screen panel is attached onto a display device in such a manner that the screen coordinates of the display device coincide with the touched point coordinates of the touch screen panel. Thus, the user can select menus or execute commands for performing operations by touching icons or characters displayed on the display screen.

Various types of touch sensors are available for a touch screen. Depending on how a touch signal is sensed, touch sensors are primarily categorized into a resistive and a capacitive overlay type. Since a resistive overlay-type touch sensor is inexpensive compared to a capacitive overlay-type touch sensor, the former is widely used in low-cost distribution portable terminals and widely used equipment such as an information terminal, a ticket machine, and an Automated Teller Machine (ATM).

The resistive overlay-type touch sensor is fabricated by forming transparent electrodes on two films through deposition of Indium-Tin Oxide (ITO) on the films (ITO films), and by interposing dot spacers between the two ITO films so that the ITO films are apart from each other. When the outer ITO film is pressed, transparent electrodes are brought into contact at the touched point and thus electrical resistance changes in the resistive overlay-type touch sensor. In this manner, the touch screen detects information about the position of a user-touched point based on a variation in electrical resistance.

FIGS. 1 and 2 illustrate a conventional resistive overlay-type touch sensor 10. The conventional resistive overlay-type touch sensor 10 includes a plurality of first substrates 11 extended in a first direction and a plurality of second substrates 13 extended along a second direction perpendicular to and facing the first substrates 11. The first and second substrates 11 and 13 are transparent films formed of a synthetic resin such as polyester. Transparent electrodes are formed by depositing ITO on one surface of each of the first and second substrates 11 and 13. The transparent electrodes formed on the first substrates 11 face the transparent electrodes formed on the second substrates 12 in a one-to-one correspondence, thus forming pressure sensors.

The first and second substrates 11 and 13 may be fabricated to the same size as a display device on which the touch sensor 10 is mounted. In this case, the transparent electrodes are arranged in a matrix on one surface of each of the first and second substrates 11 and 13, which are combined with their transparent electrodes facing each other. Dot spacers are interposed between the first and second substrates 11 and 13 to form a gap between them.

Portable terminals such as mobile terminals or tablet Personal Computers (PCs) are typically light in weight, for portability purposes. However, as the multimedia function of portable terminals has further developed, it has become increasingly difficult to fabricate small-size, lightweight portable terminals. That is, although the display size has increased for multimedia function, the large screen has become an obstacle to fabrication of a small-size, lightweight portable terminal due to the flat nature of the display device.

Accordingly, extensive research has been performed on flexible display devices. If a portable terminal is equipped with a flexible display device, the portable terminal can be folded and readily extended with its housing.

Configuring a touch sensor is difficult when implementing a touch screen with such a flexible display device. The resistive overlay-type touch sensor can accurately detect a user-touched point only when a gap is maintained between the ITO films in the above-described resistive overlay-type touch sensor. However, if the touch sensor with the ITO films facing each other is bent, the gap between the ITO films changes, thus causing frequent malfunctions of the touch sensor. Therefore, the use of a flexible display having a touch screen function in a bent state leads to limitations in executing user-intended commands.

### SUMMARY OF THE INVENTION

An aspect of the present invention is to address at least the problems and/or disadvantages and to provide at least the advantages described below. Accordingly, an aspect of the present invention is to provide a resistive overlay-type touch sensor for accurately detecting a touched point even though a flexible display device having a touch screen function is bent, and a method for fabricating the same.

Another aspect of the present invention is to provide a resistive overlay-type touch sensor for maintaining a constant gap between substrates of the touch sensor even though a touch screen panel is bent, and a method for fabricating the same.

In accordance with an embodiment of the present invention, there is provided a resistive overlay-type touch sensor for a touch screen panel, in which a plurality of first substrates are extended in parallel along a first direction, a plurality of second substrates are extended in parallel along a second direction perpendicular to the first direction, and a plurality of transparent electrodes are formed on the first and second substrates. The second substrates intersect with the first substrates, each second substrate facing alternately one and the other surfaces of the first substrates along the second direction, and each of the transparent electrodes on the first substrates faces one of the transparent electrodes on the second substrates.

In accordance with an embodiment of the present invention, there is provided a method for fabricating a resistive overlay-type touch sensor for a touch screen panel, in which a plurality of first substrates extended along a first direction are arranged in parallel (first arrangement), a plurality of second substrates extended along a second direction perpendicular to the first direction are arranged in parallel (second arrangement), and a plurality of transparent electrodes are arranged on the first and second substrates (sensor arrangement). The second substrates intersect with the first substrates, each second substrate facing alternately one and the other surfaces of the first substrates along the second direction in the second arrangement, and each of the transparent electrodes on the first substrates faces one of the transparent electrodes on the second substrates in the sensor arrangement.

### BRIEF DESCRIPTION OF THE DRAWINGS

The above and other objects, features and advantages of embodiments of the present invention will be more apparent from the following detailed description taken in conjunction with the accompanying drawings, in which:

FIG. 1 illustrates the structure of a conventional resistive overlay-type touch sensor;

FIG. 2 illustrates first and second substrates in the conventional touch sensor illustrated in FIG. 1;

FIG. 3 illustrates a part of a resistive overlay-type touch sensor according to an embodiment of the present invention;

FIG. 4 illustrates an array of first substrates in the touch sensor illustrated in FIG. 3;

FIG. 5 illustrates one surface of second substrates in the touch sensor illustrated in FIG. 3;

FIG. 6 illustrates the other surface of the second substrates in the touch sensor illustrated in FIG. 3;

FIG. 7 illustrates the touch sensor illustrated in FIG. 5, when the touch sensor is bent; and

FIG. 8 illustrates an operation for fabricating the touch sensor illustrated in FIG. 3.

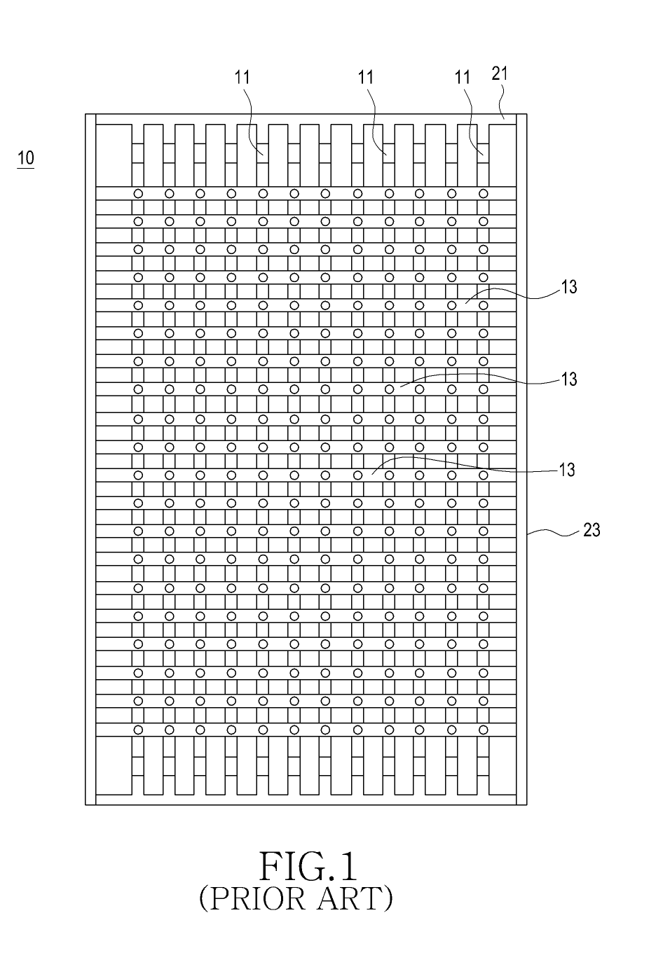

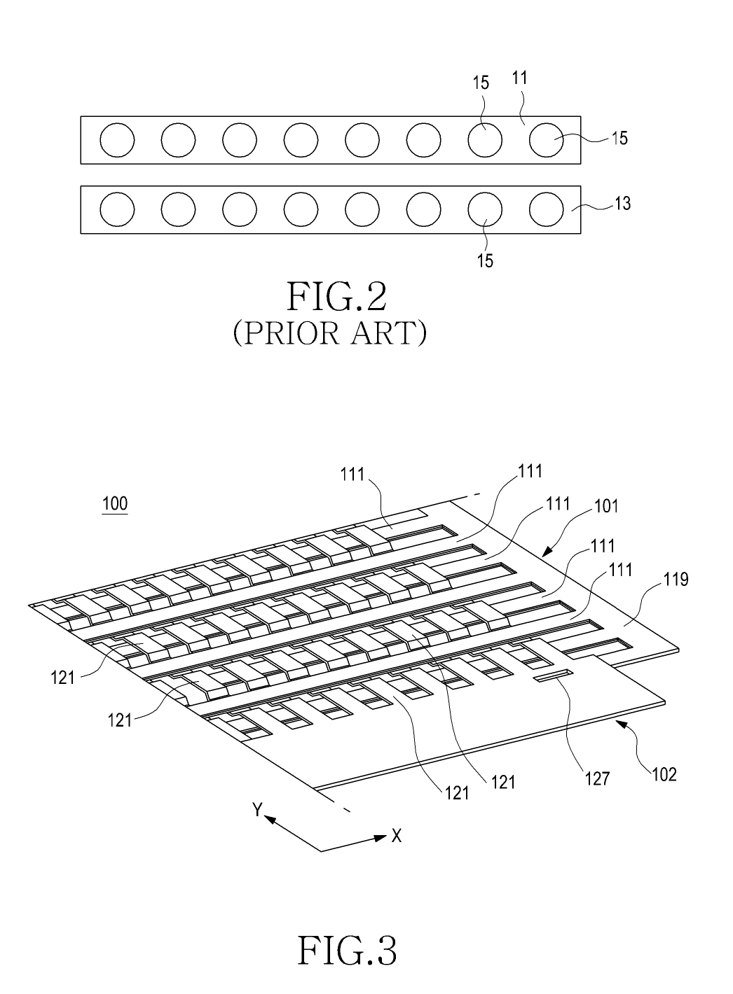

Throughout the drawings, the same drawing reference numerals will be understood to refer to the same elements, features and structures.

### DETAILED DESCRIPTION OF EMBODIMENTS OF THE INVENTION

Reference will be made to embodiments of the present invention with reference to the attached drawings. A detailed description of a generally known function and structure of the present invention will be omitted for the sake of clarity and conciseness.

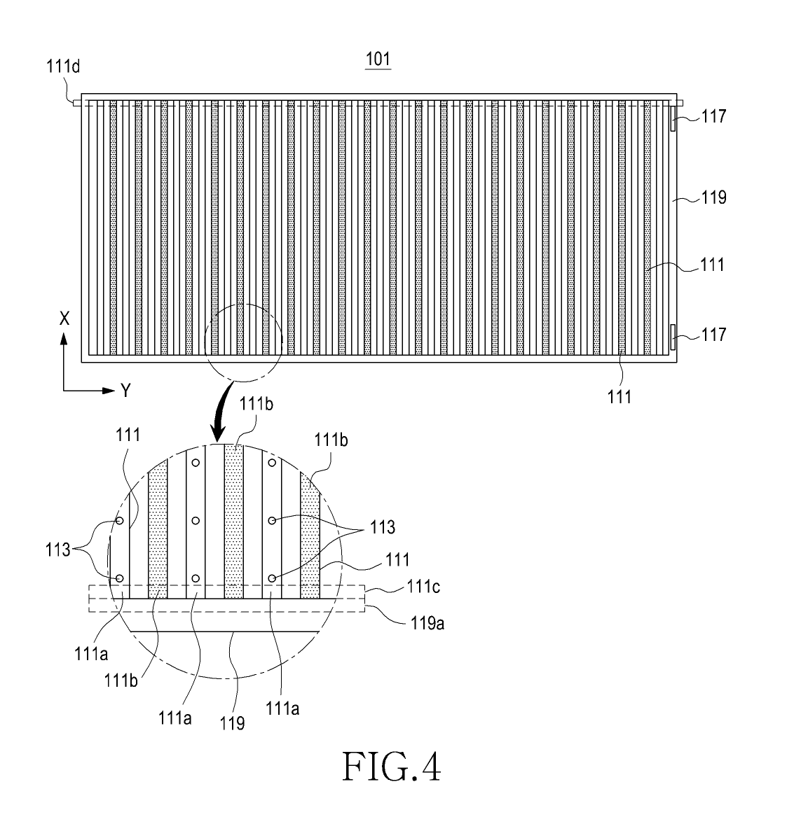

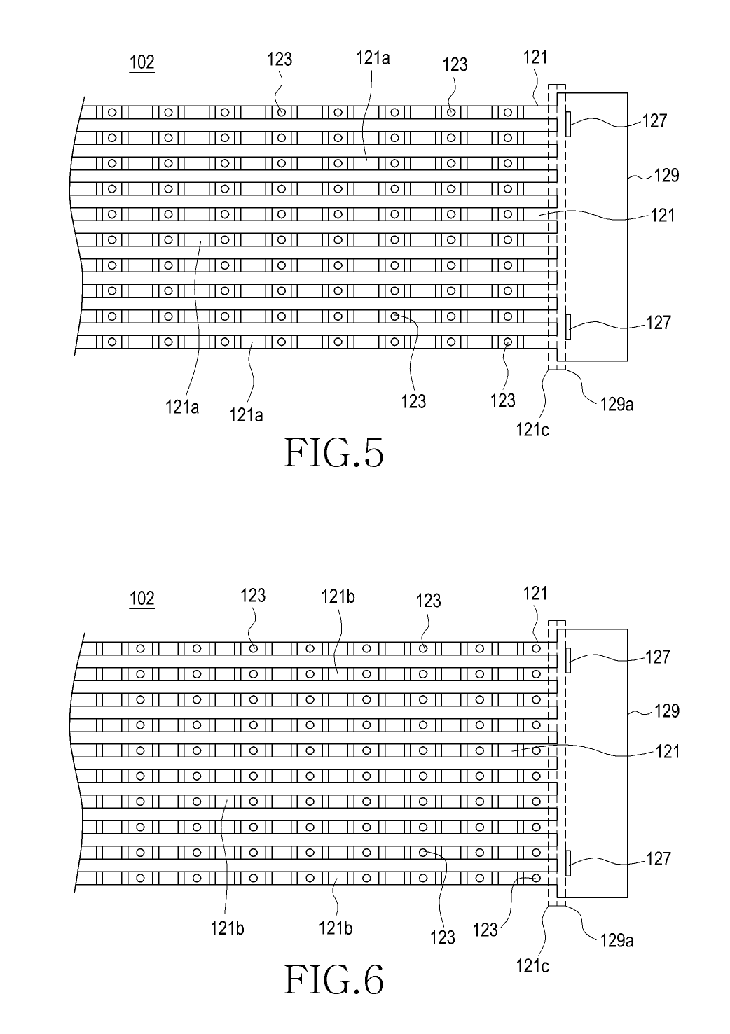

Referring to FIGS. 3 to 7, a resistive overlay-type touch sensor 100 according to the present invention includes a plurality of first substrates 111, a plurality of second substrates 121, and transparent electrodes 113 (shown in FIG. 4) and 123 (shown in FIGS. 5 and 6) arranged on the first and second substrates 111 and 121. Even though the touch sensor 100 is bent, a gap is maintained between the first and second substrates 111 and 121, thereby adapting the touch sensor 100 to a display device equipped with a touch screen function, particularly a flexible display device. That is, even though the flexible display device is bent, the first and second substrates 111 and 121 are spaced apart from each other by a constant gap in the touch sensor 100. Therefore, the touch sensor 100 is less vulnerable to malfunction and more accurately detects a touched point.

The first substrates 111 are extended along a first direction (i.e. in an X-axis direction), arranged in parallel along a second direction (i.e. in a Y-axis direction). The transparent electrodes 113 are arranged on one surface 111a of and along a length direction of the first substrates 111, which are polyester films. The transparent electrodes 113 are formed by depositing ITO on the one surface 111a of the first substrate 111. The first substrates 111 are arranged along the second direction in such a manner that the transparent electrodes of odd-numbered first substrates face upward and the transparent electrodes of even-numbered first substrates face downward. That is, the electrodes-having surfaces 111a and 111b of the first substrates 111 alternately face the top and bottom surfaces of the touch sensor 100.

At least one end 111c of each of the first substrates 111 is preferably connected to one side 119a of a first connection substrate 119. The first connection substrate 119 is extended in the second direction and conductive wires connecting the transparent electrodes 113 arranged on the first substrates 111 are collected to the first connection substrate 119. While the first connection substrate 119 may be disposed only at one ends 11c of the first substrates 111, the first connection substrate 119 is shown in FIG. 4 as surrounding an area in which the first substrates 111 are arranged, by way of example. As the first connection substrate 119 surrounds the arrangement area of the first substrates 111, both ends 111c and 111d of the first substrates 111 are preferably connected to the first connection substrate 119. Thus, the first substrates 111 and the first connection substrate 119 are formed by cutting one substrate member 101.

The second substrates 121 are extended along the second direction, and are arranged in parallel along the first direction. Alternately facing one and the other surfaces 111a and 111b of the first substrates 111 along the second direction, the second substrates 121 intersect with the first substrates 111. That is, the second substrates 121 are extended in a zigzag fashion along the second direction in such a manner that the second substrates 121 face the one surface 111a (i.e. top surface) of odd-numbered first substrates 111 and the other surface 111b (i.e. bottom surface) of even-numbered first substrates 111.

FIG. 5 illustrates an array of transparent electrodes 123 arranged on one surface 121a of the second substrates 121, and FIG. 6 illustrates an array of transparent electrodes 123 arranged on the other surface 121b of the second substrates 121. The transparent electrodes 123 are arranged along the second direction, alternately on one and the other surfaces 121a and 121b of the second substrates 121. Thus, the odd-numbered first substrates 111 face the other surface 121b of the second substrates 121, whereas the even-numbered first substrates 111 face the one surface 121a of the second substrates 121. As a result, each of the transparent electrodes 123 arranged on the second substrates 121 faces one of the transparent electrodes 113 arranged on the first substrates 111. Each pair of facing transparent electrodes 113 and 123 on the first and second substrates 111 and 123 forms a pressure sensor.

When the second substrates 121 are arranged, at least one end 121c of each of the second substrates 121 is preferably connected to one side 129a of a second connection substrate 129. The second connection substrate 129 is extended in the first direction and conductive wires connected to the transparent electrodes 123 arranged on the second substrates 121 are collected to the second connection substrate 129. The second connection substrate 129 is disposed at one end 121c of the second substrates 121. Thus, the second substrates 121 and the second connection substrate 129 are formed by cutting one substrate member 102.

The touch sensor 100 may further include an alignment unit for aligning the transparent electrodes 113 on the first substrates 111 with the transparent electrodes 123 on the second substrates 121. The alignment unit includes alignment grooves (not shown) formed into the first connection substrate 119 and alignment protrusions 127 formed on the second connection substrate 129. Preferably, there are at least one pair of alignment grooves on the first connection substrate 119 and at least one pair of alignment protrusions 127 on the second connection substrate 129. Because the first and second connection substrates 119 and 129 are formed of films, the alignment grooves and the alignment protrusions 127 may be carved. Meanwhile, the alignment unit for aligning the first and second substrates 111 and 121 is not necessarily formed into a groove and a protrusion. In other words, the alignment unit may have through holes penetrating the first and second substrates 119 and 129 and alignment jigs that use the through holes. Various physical alignment units may be configured.

When the alignment protrusions 127 are inserted into the alignment grooves after the second substrates 121 are arranged on the first substrates 111 in a zigzag fashion, each of the transparent electrodes 123 arranged on the second substrates 121 faces one of the transparent electrodes arranged on the first substrate 111, without a need for an additional alignment process.

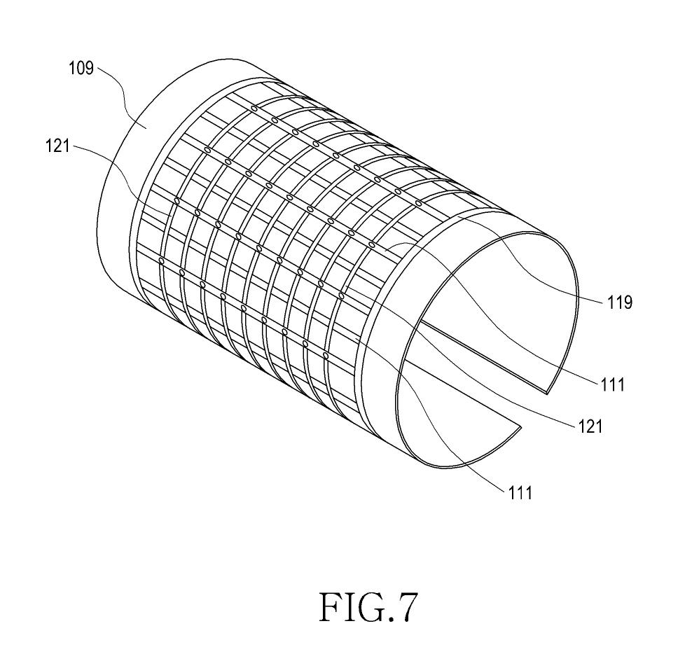

After the first and second substrates 111 and 121 are arranged, they are laminated to a transparent film (109 in FIG. 7), thereby completing the touch sensor 100 as one module. The film 109 is disposed on the exterior of a display device and the first and second substrates 111 and 121 are interposed between the film 109 and the display device. That is, the film 109 is positioned at the outermost portion of the display device, thus being exposed outward. Therefore, the film 109 is preferably a high-strength film.

While not described in detail in the present invention, it is to be readily understood that the first and second substrates 111 and 121 are apart from each other by interposing dot spacers therebetween.

FIG. 7 illustrates the touch sensor 100 in a bent state. As the second substrates 121 are arranged in a zigzag fashion, the gap between the first and second substrates 111 and 121 is maintained constant despite the bent state of the touch sensor 100. Therefore, the touch sensor 100 is applicable to a flat panel display. In addition, when a flexible display device is to be equipped with a touch screen function, the use of the touch sensor 100 according to the present invention enables accurate detection of a user's touched point even when the display device is partially bent.

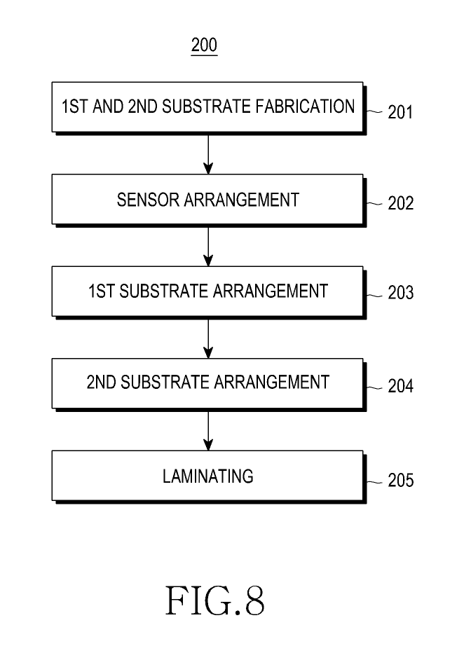

FIG. 8 illustrates a method 200 for fabricating the touch sensor 100 according to the present invention. In FIG. 8, the touch sensor fabrication method 200 includes fabricating the first and second substrates 111 and 121 in step 201, arranging sensors by forming the transparent electrodes 113 and 123 (sensor arrangement) in step 202, arranging the first substrates 111 (first arrangement) in step 203, arranging the second substrates 121 in a zigzag fashion (second arrangement) in step 204, and laminating the substrates in step 205.

In step 202, the transparent electrodes 113 and 123 are formed on the first and second substrates 111 and 121. Preferably, the transparent electrodes 113 and 123 are formed before the first and second substrates 111 and 121 are arranged. That is, considering the transparent electrodes 113 and 123 are formed by ITO deposition, it is easy to form or etch the ITO deposition layers before the first and second substrates 111 and 121 are arranged. After the first and second substrates 111 and 121 are fabricated, the transparent electrodes 113 and 123 may be formed on the fabricated first and second substrates 111 and 121. Alternatively, after the transparent electrodes 113 and 123 are formed on a substrate base film formed of synthetic resin such as a polyester, the first and second substrates 111 and 121 may be formed by cutting the substrate base film. For each of the first substrates 111, transparent electrodes 113 are limited to a single surface of the first substrate 111, whereas for each of the second substrates 121, transparent electrodes 123 are formed on both surfaces of the second substrate 121, alternately on one and the other surfaces thereof along the second direction.

The first and second substrates 111 and 121 are fabricated by cutting a substrate base film formed of transparent and insulated synthetic resin such as polyester. In this process, the exteriors of the first and second substrates 111 and 121 are completed.

After the first and second substrates 111 and 121 with the transparent electrodes 113 and 123 are completed, steps 203 and 204 are sequentially performed to thereby arrange the first substrates 111 in parallel along the first direction and the second substrates 121 in parallel in a zigzag fashion along the second direction. Specifically, first substrates 111 in even-numbered rows face the one surface of the second substrates 121 and first substrates 111 in odd-numbered rows face the other surface of the second substrates 121. Thus, each of the transparent electrodes 123 arranged on the first substrates 111 faces one of the transparent electrodes 123 arranged on the second substrates 121.

After the first and second substrates 111 and 121 are completely arranged, the first and second substrates 111 and 121 are laminated to one surface of the transparent film 109 in step 205. Since a user touches the film 109 to enter an intended command on a screen displayed on the display device, the film 109 is preferably high in strength.

In step 201, the first and second connection substrates 119 and 129 and the alignment unit, are preferably formed in order to facilitate handling and alignment of the first and second substrates 111 and 121.

The first connection substrate 119 surrounds an area in which the first substrates 111 are arranged or is extended along the second direction on at least one side of the arrangement area of the first substrates 111. One end 111c of each of the first substrates 111 is connected to the first connection substrate 119. If the first connection substrate 119 surrounds the arrangement area of the first substrates 111, both ends 111c and 111d of the first substrates 111 are preferably connected to the first connection substrate 119. Accordingly, the first connection substrate 119 may be formed using a part of the substrate base film during fabricating the first substrates 111.

In the first and second substrate fabrication step 201, the second connection substrate 129 is extended along the first direction at one side of the arrangement area of the second substrates 123 and one end 121c of each of the second substrates 121 is connected to the second connection substrate 129. Therefore, the second connection substrate 129 may be formed using a part of the substrate base film during fabrication of the second substrates 121.

Meanwhile, the transparent electrodes 123 arranged on the second substrates 121 are aligned to face the transparent electrodes 113 of the first substrates 111, so that each pair of facing transparent electrodes 113 and 123 forms a pressure sensor in the second arrangement step 204. While the transparent electrodes 113 and 123 may be aligned using an additional alignment device, they are aligned by means of the alignment unit formed on the first and second connection substrates 119 and 129 in the touch sensor 100.

During formation of the first and second connection substrates 119 and 129, the alignment grooves and the alignment protrusions 127 may also be formed on the first and second connection substrates 119 and 129, respectively. For example, if the alignment grooves are formed into the first connection substrate 119, the alignment protrusions 127 are formed on the second connection substrate 129. In the second arrangement step 204, the transparent electrodes 113 and 123 may be aligned to face each other by partially overlapping the second connection substrate 129 with the first connection substrate 119 and inserting the alignment protrusions 127 into the alignment grooves. At least one pair of alignment grooves and at least one pair of alignment protrusions 127 are preferably formed.

As is apparent from the above description, the resistive overlay-type touch sensor according to the present invention is mounted on a flexible display device. Even though the display device is bent, the touch sensor can accurately detect a touched point on the display device because the gap between the first and second substrates is constant.

While the present invention has been particularly shown and described with reference to embodiments thereof, it will be understood by those of ordinary skill in the art that various changes in form and details may be made therein without departing from the spirit and scope of the present invention as defined by the following claims.

For example, while it has been described that the first and second substrates are formed of films of transparent synthetic resin such as polyester, these synthetic resin films may be replaced with general Flexible Printed Circuit Boards (FPCBs). However, it is to be noted that the touch sensor of the present invention should be formed of a transparent material because the touch sensor implements a touch screen function in combination with a display device.

What is claimed is:

1. A resistive overlay-type touch sensor for a touch screen panel, comprising:
a plurality of first substrates extended in parallel along a first direction;
a plurality of second substrates extended in parallel along a second direction perpendicular to the first direction; and
a plurality of transparent electrodes on the first and second substrates,
wherein the second substrates intersect with the first substrates, each second substrate facing alternately one and other surfaces of the first substrates along the second direction, and each of the transparent electrodes on the first substrates faces one of the transparent electrodes on the second substrates.

2. The resistive overlay-type touch sensor of claim 1, wherein the first and second substrates are Flexible Printed Circuit Boards (FPCBs).

3. The resistive overlay-type touch sensor of claim 1, further comprising:
a first connection substrate extended along the second direction; and
a second connection substrate extended along the first direction,
wherein each of the first substrates is extended from one side of the first connection substrate and each of the second substrates is extended from one side of the second connection substrate.

4. The resistive overlay-type touch sensor of claim 1, further comprising:
a first connection substrate surrounding the first substrates; and
a second connection substrate extended along the first direction,
wherein both ends of the first substrates are connected to the first connection substrate and each of the second substrates is extended from one side of the second connection substrate.

5. The resistive overlay-type touch sensor of claim 4, further comprising an alignment unit formed on the first and second connection substrates.

6. The resistive overlay-type touch sensor of claim 1, wherein for each of the first substrates, transparent electrodes are arranged along a length direction of the first substrate on a single surface of the first substrate, and for each of the second substrates, transparent electrodes are arranged along a length direction of the second substrate, alternately on one and the other surfaces of the second substrate.

7. A method for fabricating a resistive overlay-type touch sensor for a touch screen panel, comprising:
arranging a plurality of first substrates to extend in parallel along a first direction;
arranging a plurality of second substrates to extend in parallel along a second direction perpendicular to the first direction; and
arranging a plurality of transparent electrodes on the first and second substrates,
wherein the second substrates intersect with the first substrates, when arranging the plurality of second substrates each second substrate faces alternately one and other surfaces of the first substrates along the second direction, and when arranging the plurality of transparent electrodes each of the transparent electrodes on the first substrates faces one of the transparent electrodes on the second substrates.

8. The method of claim 7, wherein the plurality of first and second substrates is arranged after the plurality of transparent electrodes are arranged.

9. The method of claim 7, further comprising:
arranging a first connection substrate extended along the second direction at least one side of an arranged area of the first substrates; and
fabricating the first substrates with one end of each of the first substrates connected to the first connection substrate.

10. The method of claim 9, wherein the first connection substrate surrounds the arranged area of the first substrates and both ends of the first substrates are connected to the first connection substrate.

11. The method of claim 7, further comprising:
arranging a second connection substrate to extend along the first direction; and
fabricating the second substrates with one end of each of the second substrates connected to the second connection substrate.

12. The method of claim 11, further comprising:
arranging a first connection substrate to extend along the second direction on at least one side of an arranged area of the first substrates; and
fabricating the first substrates with one end of each of the first substrates connected to the first connection substrate.

13. The method of claim 12, wherein the first connection substrate surrounds the arranged area of the first substrates and both ends of the first substrates are connected to the first connection substrate.

14. The method of claim 12, further comprising forming an alignment unit on the first and second connection substrates, wherein the second connection substrate is overlapped with a part of the first connection substrate at a predetermined position using the alignment unit.

15. The method of claim 7, further comprising mounting the first and second substrates on one surface of a transparent film and laminating the first and second substrates to the transparent film.

16. The method of claim 7, wherein the first and second substrates are Flexible Printed Circuit Boards (FPCBs).
